(19) United States
(12) Patent Application Publication
(10) Pub. No.: US 2025/0374413 A1
(43) Pub. Date: Dec. 4, 2025

(54) CYCLOTRON AND METHOD FOR OPERATING THE CYCLOTRON

(71) Applicant: Ion Beam Applications S.A., Louvain-la-Neuve (BE)

(72) Inventor: Alexander Thomas HERROD, Louvain-La-Neuve (BE)

(73) Assignee: Ion Beam Applications S.A., Louvain-la-Neuve (BE)

(21) Appl. No.: 19/220,750

(22) Filed: May 28, 2025

(30) Foreign Application Priority Data
May 31, 2024 (EP) EP24179376

(51) Int. Cl. H05H 13/00; H05H 7/04

(52) U.S. Cl. CPC H05H 13/005; H05H 7/04

(57) ABSTRACT

A cyclotron includes a particle acceleration chamber, an upper part above the particle acceleration chamber and a lower part below the particle acceleration chamber, a plurality of rotatable pieces for generating a magnetic field in the particle acceleration chamber, wherein: at least one of the rotatable pieces is at least partly made of a permanent magnet material, the at least one of the rotatable pieces extends along a respective axis, the at least one of the rotatable pieces is rotatable about the respective axis between a plurality of angular positions, the at least one of the rotatable pieces has a plurality of cross sections. A first of the cross sections closer to the central axis of the cyclotron is smaller than a second of the cross sections farther from the central axis of the cyclotron.

### CROSS REFERENCE TO RELATED APPLICATIONS

This application claims priority to European Patent Application No. EP24179376, filed May 31, 2024. The entire contents of the aforementioned application are incorporated herein by reference.

### TECHNICAL FIELD

The disclosure pertains to a cyclotron and to a method for operating the cyclotron.

### BACKGROUND

In current cyclotrons the magnetic circuit is made up of two symmetrical poles arranged on either side of a median plane and separated by a gap in which the accelerated particles circulate. The magnetic circuit is completed by flux returns in order to close said circuit and yokes serving as base plates for the poles. The poles are surrounded by a pair of induction coils traversed by a current, which generates a uniform and constant magnetic field able to confine the particles according to an essentially circular trajectory or more precisely according to a spiral-shaped trajectory in the median plane.

Also, machines with azimuthal field variation have been designed. The poles of the electromagnet are then divided into sectors having alternately a reduced gap and a larger gap.

The excitation of the magnets used in the cyclotrons requires high electric power. In view of development of greener cyclotron, there is an interest in producing cyclotrons that offer low energy consumption.

Document U.S. Pat. No. 7,466,085 describes a cyclotron configured with a plurality of dees and a plurality of permanent magnets alternately disposed in a circular array, each defining a channel through which ions travel.

Whereas attempts have been made to provide a permanent magnet cyclotron, there is still a need for a cyclotron that makes it possible to optimize a variable magnetic field for a given cyclotron footprint.

### SUMMARY

An object of the disclosure is to provide a cyclotron comprising: a particle acceleration chamber, rotatable pieces for generating a magnetic field in the particle acceleration chamber, an upper part above the particle acceleration chamber and a lower part below the particle acceleration chamber, the upper part and the lower part being configured to be separable from one another, wherein at least part of the rotatable pieces
each are at least partly made of a permanent magnet material,
each extend along a respective axis, the respective axes being oriented such that an extremity of the rotatable pieces is closer to a central axis of the cyclotron than another extremity,
each are rotatable about their respective axis between several positions, the magnetic field generated by the rotatable pieces in the chamber depending on the position of the rotatable pieces about their respective axis, and
each have cross-sections situated closer to the central axis of the cyclotron which are smaller than other cross-sections which are situated farther from the central axis of the cyclotron, the cross-sections of the rotatable pieces being transverse to their respective axis.

According to an embodiment, the cross-sections of the rotatable pieces decrease along the respective axis towards the extremity of the rotatable pieces that is closer to the central axis.

According to an embodiment, the rotatable pieces have a truncated cone shape, the cross-sections of the rotatable pieces decreasing towards the extremity of the rotatable pieces that is closer to the central axis.

According to an embodiment, the cyclotron further comprises a return yoke surrounding the particle acceleration chamber, the rotatable pieces being in the return yoke.

According to an embodiment, the particle acceleration chamber is according to a median plane, the respective axes of the rotatable pieces are obliquely pointing towards the median plane or are parallel to the median plane.

According to an embodiment, the respective axes of the rotatable pieces point towards the central axis.

According to an embodiment, the rotatable pieces each comprise a stack of permanent magnet plates fixed to one another, plates situated closer to the central axis of the cyclotron have surfaces with an area smaller than the surface area of plates situated farther from the central axis of the cyclotron.

According to an embodiment, at least part of the rotatable pieces each comprise a first portion surrounding at least partly the respective axis, the first portion being located between two planes parallel to and on either side of the respective axis, the first portion being of a permanent magnet material, and other portions beyond the two planes, opposite the respective axis, the other portions being of material of magnetic relative permeability greater than 1.

According to an embodiment, in one position of the rotatable pieces, the magnitude of the vertical magnetic field is maximum in the particle acceleration chamber and, in another position of the rotatable pieces, the magnitude of the vertical magnetic field is minimized in the particle acceleration chamber.

According to an embodiment, the rotatable pieces are continuously rotatable.

According to an embodiment, the rotatable pieces are accessible from the outside of the cyclotron to rotate them towards the respective position.

According to an embodiment, the rotatable pieces are rotatable independently of each other.

According to an embodiment, the cyclotron further comprises one or more electrically powered coils, the electrically powered coils being configured to apply a magnetic field in the chamber by powering the coils.

According to an embodiment, the particle acceleration chamber is according to a median plane between the upper part and the lower part, the cyclotron comprising the rotatable pieces being in two symmetrical sets with respect to said median plane.

The disclosure also relates to a method for operating the cyclotron as described above, comprising
rotating at least some of the rotatable pieces towards respective positions, wherein, in one position of the rotatable pieces, the magnitude of the vertical magnetic field is maximized in the particle acceleration chamber and in another position of the rotatable pieces, the magnitude of the vertical magnetic field is minimized in the particle acceleration chamber, and/or
in the position of the rotatable pieces where the magnitude of the vertical magnetic field is minimized in the particle acceleration chamber, opening the cyclotron by separating the upper part and the lower part from one another.

In the framework of this document, the use of the indefinite article “a”, “an” or the definite article “the” to introduce an element does not exclude the presence of a plurality of these elements. In this document, the terms “first”, “second”, “third” and the like are solely used to differentiate elements and do not imply any order in these elements.

In the framework of the present document, the use of the verbs “comprise”, “include”, “involve” or any other similar variant, as well as their conjugational forms, cannot exclude the presence of elements other than those mentioned. When the verb “comprise” is used for defining an interval by the terms “comprised between” two values, these two values should not be interpreted as excluded from the interval.

All the embodiments of the cyclotron according to the disclosure and the advantages of this embodiment apply mutatis mutandis to the present method, and vice versa.

### BRIEF DESCRIPTION OF THE FIGURES

Other characteristics and advantages of the present disclosure will appear on reading the following detailed description, for the understanding of which, it is referred to the attached figures where:

FIG. 1 illustrates the cyclotron according to one embodiment;

FIG. 2 illustrates the cyclotron of FIG. 1;

FIG. 3 illustrates the cyclotron according to another embodiment;

FIG. 4 illustrates the cyclotron of FIG. 3;

FIG. 5 illustrates the cyclotron of FIG. 3;

FIG. 6 illustrates a rotatable piece of the cyclotron;

FIG. 7 illustrates a permanent magnet part of a rotatable piece of the cyclotron;

FIG. 8 illustrates a coil of the cyclotron.

The drawings in the figures are not scaled. Similar elements can be assigned by similar references in the figures. In the framework of the present document, identical or analogous elements may have the same references. The presence of reference numbers in the drawings cannot be considered to be limiting, in particular if these numbers are indicated in the claims.

### DESCRIPTION OF EMBODIMENTS

Description of preferred embodiments of the present disclosure are hereafter described with references to figures, but the disclosure is not limited by these references. In particular, the drawings or figures described below are only schematic and are not limiting in any way.

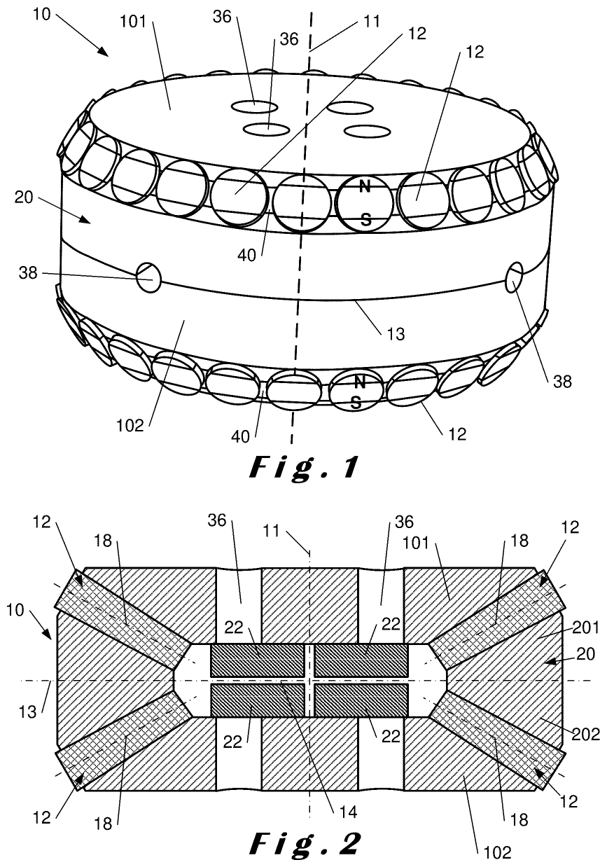

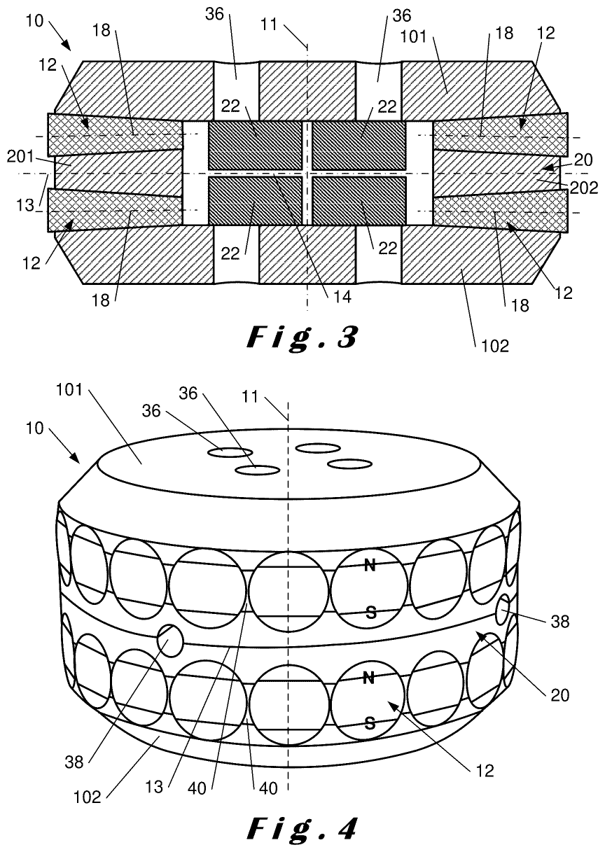

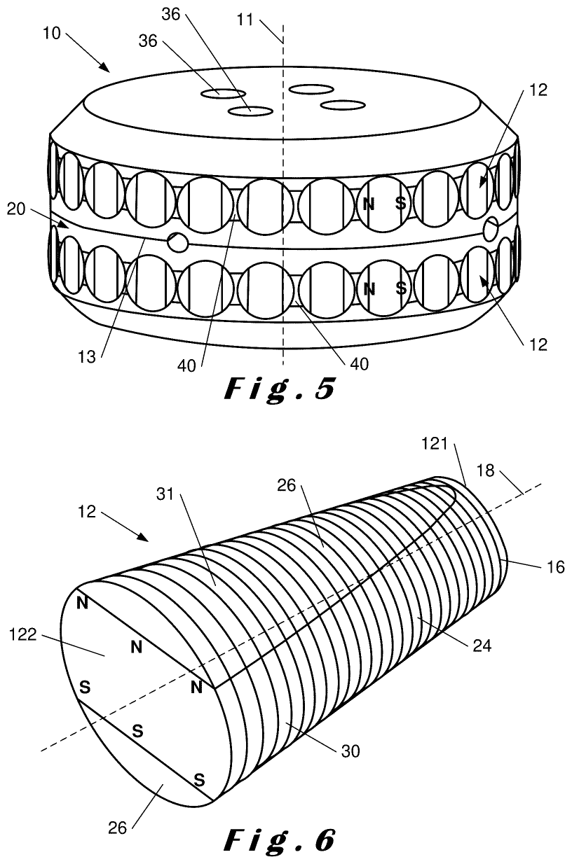

FIGS. 1-5 illustrate different embodiments of a cyclotron 10 according to the disclosure. The cyclotron 10 is a re-circulation particle accelerator, in which charged particles (positive ions (such as protons, deuterons, helions, alpha particles, etc.) or negative ions such as (H-, D-, etc.)), generated by an ion source, are accelerated in a circular motion in a particle acceleration chamber 14 under vacuum, schematically visible on FIG. 2 or 3. This is achieved by using a magnetic field which causes the particles, coming from said source, to follow a circular path, or more precisely according to a spiral-shaped path, in the particle acceleration chamber 14, in a median plane 13 perpendicular to said magnetic field. The cyclotron 10 has a central axis 11 perpendicular to the median plane 13. The particles are accelerated in a circular motion in the median plane 13 around the central axis 11. The central axis 11 is perpendicular to the particle acceleration chamber 14.

FIGS. 1 to 5 illustrate various embodiments of cyclotron 10. The cyclotron 10 has an upper part 101 above the median plane 13 and comprising an upper yoke. The cyclotron 10 also has a lower part 102 below the median plane 13 and comprising a lower yoke. Cyclotron 10 also includes a return yoke 20. The return yoke closes the magnetic field. Return yoke 20 is at the periphery of cyclotron 10. Return yoke 20 surrounds the particle acceleration chamber 14. Return yoke 20 surrounds a central region which can be defined as a cylindrical volume around the central axis 11. The central region may encompass the particle acceleration chamber 14. The return yoke 20 connects the upper yoke and the lower yoke. The return yoke 20 may comprise an upper return yoke 201 and a lower return yoke 202. The upper return yoke 201 and the lower return yoke 202 are supported by and are integral with the upper part 101 and the lower part 102, respectively. Not visible in the figures, the cyclotron 10 may comprises a particle injection device along the central axis 11 and a central duct so as to allow charged particles to be injected into the particle acceleration chamber 14, at the center of the cyclotron. The central duct is in either the upper part 101 or the lower part 102, for example the upper part 102. Alternatively, the cyclotron 10 may comprise an internal particle source.

The upper part 101 and the lower part 102 are separated from each other by the median plane 13. The upper part 101 and the lower part 102 may be symmetrical or not symmetrical with respect to the median plane 13. The upper yoke of the upper part 101 and the lower yoke of the lower part 102 support several poles 22 (for example divided into sectors) arranged in such a way as to have alternating zones with a narrow (or reduced) gap called “hills” and zones with a wide (or larger) gap called “valleys”, so as to ensure relocation of the particle beam in the median plane 13. According to the median plane 13 that is perpendicular to the central axis 11, the poles 22 of the upper and lower yokes are separated from each other by a gap defining the particle acceleration chamber 14 and in which the accelerated particles circulate. The poles 22 are for example made of steel.

The upper part 101 and the lower part 102 are configured to be separable from each other. In other words, the cyclotron 10 is configured to be openable, so as to provide access to the inside of the cyclotron 10. This provides access to the chamber 14 and the poles 22. This facilitates the tuning of the cyclotron 10 and facilitates maintenance operations on the cyclotron 10. The upper return yoke 201 and the lower return yoke 202 are also configured to be separable from each other in order to open the cyclotron 10.

The magnetic field is generated fully or in-part by pieces 12. The pieces 12 may be rotatable. In the remainder of the description, any reference to a “rotatable piece 12” or to “rotatable pieces 12” applies to all or part of the pieces 12. The disclosure preferably applies to all of rotatable pieces 12.

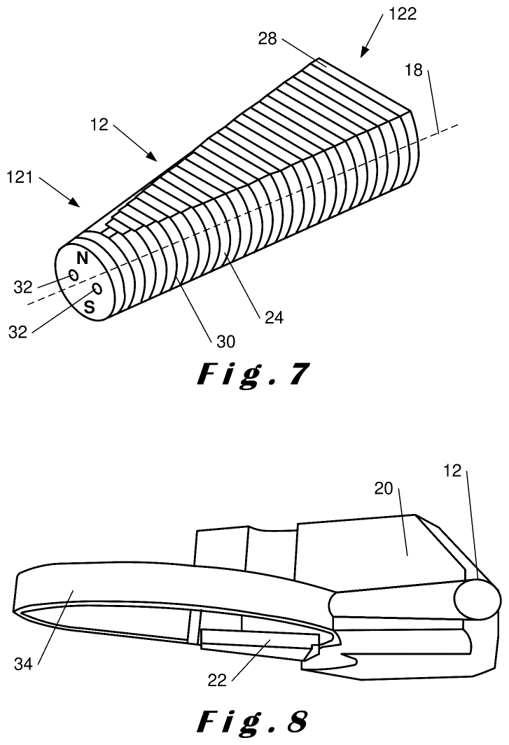

FIGS. 6 and 7 illustrate an example of rotatable piece 12, and especially its geometry. The rotatable pieces 12 are at least partly made of a permanent magnet material 16. The use of permanent magnet 16 makes it possible to create a magnetic field while optimising electricity consumption, and more particularly reducing electricity consumption. When the cyclotron is in use, the rotatable piece 12 does not consume electricity to generate the magnetic field that bends particle trajectories, which is advantageous from an environmental point of view. According to FIG. 6, North and South poles allow the generation of a magnetic field along closed field lines between the North pole and the South pole, outside the rotatable piece 12. Once assembled in the cyclotron, the rotatable pieces 12 are used to generate the magnetic field in the particle acceleration chamber. In particular the magnetic field is vertical in the particle acceleration chamber, enabling the acceleration of the particles. The magnetic field is also closed by the return yoke 20. The permanent magnet material 16 can be of SmCo (Samarium-Cobalt). This may reduce activated waste. NdFeB (Neodymium) magnets activate more easily, but could also be used. The disclosure is not limited to these materials but other material can be used, depending on the required magnetic strength.

The rotatable pieces 12 extend along a respective axis 18. The rotatable pieces 12 each extend along a respective axis 18. Each of said rotatable pieces 12 extends along one respective axis 18. In other words, one rotatable piece 12 extends along one axis 18. FIG. 6 shows the axis 18 of the rotatable piece 12. The rotatable piece 12 extends along the axis 18. The rotatable piece 12 has an elongated shape along the axis 18. The longest dimension of the piece is along axis 18. The rotatable piece 12 is longer along the axis 18 compared to its other dimension. The rotatable piece 12 extends essentially along one dimension, i.e., along the axis 18. The ratio between the dimension of the rotatable piece along the axis 18 and a dimension transverse to the axis 18 is for example between 2 and 3, preferably between 2.5 and 2.6. Transversely to the axis 18, the cross-section of the rotatable piece 12 is of the same shape along the axis 18 (but possibly not of the same dimension as explained hereinbelow).

In addition, the respective axes 18 are oriented such that an extremity 121 of the rotatable pieces 12 is closer to the central axis 11 of the cyclotron than another extremity 122. The rotatable pieces 12 each have the respective axis 18 being oriented such that an extremity 121 of the rotatable pieces 12 is closer to a central axis of the cyclotron 10 than another extremity 122. In FIG. 6, the rotatable piece 12 is elongated along the axis 18 and extend between the two extremities 121 and 122. The extremities 121 and 122 are the farthest points from a center of the rotatable piece 12. The extremities 121 and 122 are the farthest points from the center of the rotatable piece 12 and situated on the axis 18. The axis 18 is oriented in cyclotron 10 so that extremity 121 is closer to axis 11 than extremity 122. The extremity 121 faces the central axis 11 and the extremity 122 faces away from the central axis 11, towards the periphery of the cyclotron. The axes 18 are oriented towards the central region of the cyclotron 10.

Further, the rotatable pieces 12 each are rotatable about their respective axis 18 between several positions. The pieces 12 are mobile in rotation. The angular position of each rotatable piece 12 is adjustable about the respective axis 18. The pieces 12 are each rotatable about their respective axis 18. In FIG. 6, the piece 12 is rotatable about the axis 18. Rotation of the rotatable piece 12 enables the rotatable piece to be positioned in different angular positions about the axis 18. Rotatable piece 12 is symmetric about respective axis 18. Whatever the plane transverse to respective axis 18, the cross-section of the rotatable piece 12 in this plane has the same dimension in all directions. In cross-section transverse to respective axis 18, the rotatable piece 12 is circular around axis 18. Depending on the (angular) position of the rotatable pieces 12 in the cyclotron, the position of the North and South poles of each rotatable piece 12 varies, which changes the strength and/or orientation of the magnetic field generated in the particle acceleration chamber 14. The magnetic field generated by the rotatable pieces 12 in the chamber 14 depends on the position of the rotatable pieces 12 about their respective axis 18. The magnetic field in the particle acceleration chamber is adjusted as a function of the respective position of the rotatable pieces 12. This makes it possible to have a variable magnetic field and to adjust the magnetic field in the particle acceleration chamber. In addition, the rotatable piece 12 can be removed in order to be replaced in case of demagnetization of the permanent magnet material 16. The rotatable pieces 12 have structural rigidity to sustain rotational torques during angular adjustment.

Furthermore, the rotatable pieces 12 each have cross-sections situated closer to the central axis 11 of the cyclotron 10 which are smaller than other cross-sections situated farther from the central axis 11 of the cyclotron 10. The cross-sections of the rotatable pieces are transverse to their respective axis 18. Certain rotatable piece cross-sections that are close to the central axis 11 are smaller than other rotatable piece cross sections that are away from the central axis 11. On FIG. 6, the area of rotatable piece cross-sections that are closer to the extremity 121 (which is closer to the central axis 11 than the extremity 122) is smaller than the area of rotatable piece cross sections closer to the extremity 122 (which is closer to the periphery of the cyclotron than the extremity 121). This allows the rotatable pieces 12 to be arranged in the cyclotron in an optimised manner relative to one another. The rotatable pieces 12 are arranged so that their smaller cross-sections are located more towards the inside of the cyclotron and the larger cross-sections are located more towards the periphery of the cyclotron. The smaller available space of the cyclotron towards the central axis 11 is occupied by the less voluminous segments of the rotatable pieces 12 and the larger available space of the cyclotron towards the periphery of the cyclotron is occupied by the more voluminous segments of the rotatable pieces 12. This makes it possible to optimise the arrangement of the rotatable pieces 12 in the cyclotron, and therefore to optimise the magnetic field in the particle acceleration chamber, in relation to the footprint of the cyclotron. The cyclotron 10 is compact.

Thus, thanks to the shape, symmetry and orientation of the pieces 12 and axes 18, the cyclotron 10 optimises a variable magnetic field for a given cyclotron footprint. Both current consumption and footprint are optimised. Also, the cyclotron 10 provides a permanent magnet cyclotron maximizing the amount of permanent magnet (and field between the poles) for a given cyclotron footprint, whose magnetic field can be cancelled to assist with isochronising and/or opening the cyclotron.

In figures, vertical holes 36 for vacuum pumps are visible through upper part 101 and/or lower part 102. This is to give access to the particle acceleration chamber 14 to create vacuum. Other equipment may also be inserted through vertical holes 36. Also, radial holes 38 at 90° intervals on the periphery of the return yoke 20 may be foreseen. The holes 38 are for beam extraction and instrument access.

To further optimize the variable magnetic field for a given cyclotron footprint, and to ease its construction, the respective axes 18 of the rotatable pieces 12 are obliquely pointing towards the median plane 13 or are parallel the median plane 13. According to FIGS. 1 to 5, the respective axes 18 are oriented towards the central region of the cyclotron. In the embodiment of FIGS. 1 and 2, the respective axes 18 are oriented obliquely in the cyclotron 10. The respective axes 18 point towards the median plane 13. The respective axes 18 are not parallel and not perpendicular to the central axis 11 nor to the median plane 13. The respective axes 18 are, for example, oriented diagonally in the cyclotron 10. The rotatable pieces 12 are positioned in the cyclotron so that the extremity 121 is directed towards the median plane 13 and the extremity 122 is directed towards the periphery of the cyclotron. The respective axis 18 of the rotatable pieces 12 is inclined from the periphery of the cyclotron towards the median plane 13. For example, an angle between the respective axis 18 of the rotatable pieces 12 and the median plane 13 is for example between 10° and 80°, preferably between 30° and 60°. In the embodiment of FIGS. 3 to 5, the respective axes 18 are oriented parallel to the median plane 13 of the cyclotron 10. The respective axes 18 are horizontal. The rotatable pieces 12 are positioned in the cyclotron so that the extremity 121 is not directed towards the median plane 13 and the extremity 122 is directed towards the periphery of the cyclotron. The respective axis 18 of the rotatable pieces 12 extends from one point of the periphery of the cyclotron towards another point of the periphery of the cyclotron.

Even more preferably, and to further improve the optimisation of the variable magnetic field for a certain footprint of the cyclotron and to further ease its construction, the respective axes 18 of the rotatable pieces 12 are pointing towards the central axis 11. In the embodiment of FIGS. 1 and 2, the rotatable pieces 12 are positioned in the cyclotron so that the extremity 121 is directed obliquely towards the central axis 11 and the extremity 122 is directed towards the periphery of the cyclotron. The respective axis 18 of the rotatable pieces 12 is inclined from the central axis 11 towards the periphery of the cyclotron. The oblique direction of the respective axis 18 makes it possible to have longer rotatable pieces 12, and thus, to generate increased magnetic field. In the embodiment of FIGS. 3 to 5, the rotating pieces 12 are positioned in the cyclotron so that the extremity 121 is directed towards the central axis and the extremity 122 is directed towards the periphery of the cyclotron, with the respective axis 18 of the rotating piece 12 parallel to the median plane 13. The respective axis 18 of the rotating pieces is along a diameter of the cyclotron 10.

The rotatable pieces 12 can be positioned in the return yoke 20, which makes it possible to position the rotatable pieces 12 around the central region of the cyclotron, and in particular around the particle acceleration chamber 14. It is also easier to integrate the rotatable pieces 12 into the return yoke. Receptacles are provided in the return yoke 20 to house the rotatable pieces 12. A partition wall 40 of non-magnetic material may be provided between the rotatable pieces 12. This prevents the magnetic field from dissipating in the material of the partition wall 40. Preferably, the rotatable pieces 12 (and thus the permanent magnet material) are away from the cyclotron median plane 13. This reduces activation from the accelerated particles. Further, the rotatable pieces may be in two symmetrical sets with respect to the median plane 13. This simplifies the manufacture of the cyclotron and helps to open it up. It also simplifies the operation of the cyclotron 10. The sets are also symmetric about cyclotron central axis 11, in order to generate the maximum magnetic field.

According to FIGS. 6 and 7, the cross-sections of the rotatable piece 12 decrease along the respective axis 18 towards the extremity 121 of the rotatable piece 12 that is closer to the central axis 11. The area of the cross-sections of the rotatable piece 12 decreases from one extremity 122 to the other extremity 121. The decrease may be continuous or discontinuous. The area of the cross-sections of the rotatable piece 12 varies from the extremity 122 to the extremity 121. The variation may be continuous or discontinuous. This optimises the arrangement of the rotatable pieces 12 in the cyclotron.

Preferably, the diameter of the rotatable pieces 12 decreases in function of the length of the rotatable pieces 12. The decrease is towards extremity 121. In an embodiment, the rotatable pieces 12 may be of a succession of cylinders abutted to each other, so that the diameters are decreasing stepwise towards the extremity 121. In a preferred embodiment, the rotatable pieces 12 have a truncated cone shape, the cross-sections of the rotatable pieces 12 decreasing towards the extremity 121 that is closer to the central axis. The rotatable pieces 12 have a cone shape with a truncated tip. The smallest cross-section of the rotatable pieces 12 is more towards the inside of the cyclotron. The advantage of a truncated cone shape is that it is easier to arrange in the cyclotron, makes it easier to adjust the position around axis 18 and optimises the use of space within the cyclotron.

The manufacture of the rotatable pieces 12 is now described. At least part of the rotatable pieces each comprise different portions. A first portion 24 is surrounding at least partly the respective axis 18. The first portion 24 is located between two parallel planes parallel to and on either side of the respective axis 18. The first portion 24 is of a permanent magnet material 16. Further, the rotatable pieces 12 each comprise other portions 26 beyond the two parallel planes, opposite the respective axis 18. FIGS. 6 and 7 show in detail the manufacture of the rotatable piece 12. The rotatable piece 12 has interfaces 28 corresponding to the planes parallel to and on either side of the respective axis 18. The interfaces 28 are formed by flat surfaces on the sides, the interfaces 28 lying along the parallel planes. The interfaces 28 are parallel to the respective axis 18, on either side of the axis. The interfaces 28 are symmetrical with respect to the respective axis 18. The rotatable piece 12 has two lateral flat sides. The interfaces 28 increase the magnetic flux generated by the permanent magnet material 16 while limiting the volume and cost of this material. One interface 28 is the North pole and the other interface 28 is the South pole of the rotatable piece 12. North and South poles allow the generation of the magnetic field along closed field lines between the North pole and the South pole, outside the rotatable piece 12. Turning to the other portions 26, said portions 26 are of material of magnetic relative permeability greater than 1. The material of the portions 26 completes the geometry of the rotatable piece 12, according to the description given in this text. In particular, the material of the portions 26 enables the piece 12 to be rotatable about the axis 18. The material of the portions 26 makes it possible to impart rotational symmetry to the rotating piece 12. The material of the portions 26 makes it possible to complete the geometry of the rotatable pieces 12 at a lower cost. The material of the portions 26 is steel, for example.

According to FIG. 7, the rotatable pieces 12 each comprise a stack of permanent magnet plates 30 (or slabs) fixed to one another. The plates 30 situated closer to the central axis 11 of the cyclotron 10 have surfaces with an area smaller than the surface area of plates 30 situated farther from the central axis 11 of the cyclotron 10. Each plate 30 has opposite sides that are constituting the interfaces 28. The opposite sides are constituting the North pole and the South pole. Each plate 30 constitutes a permanent magnet that is of a simple structure. The assembly of all of the plates 30 leads to the manufacture of portion 24 of a given rotatable piece. The stack of plates 30 constitutes the desired geometry of the rotatable pieces 12 made of permanent magnet material 16. Each plate 30 can be a cylinder with small dimension along axis 18 with respect to dimension transverse to axis 18. In other words, each plate 30 is made of a disc. Rotatable pieces 12 (for example in the form of cones) are thus manufactured from concentric discs. Discs could be made of small cubic cells of permanent magnet such as an aluminium frame with small (1 cm³) permanent magnet cubes inserted. Discs could be made of larger, shaped slabs of permanent magnet. Use of plates 30 makes it easier to manufacture the rotatable pieces 12. Rotatable pieces 12 are simplified for manufacture, transport and/or assembly.

The manufacturing process of a rotatable piece 12 can be described as follows—as a matter of example. The plates 30 (or slabs) of permanent magnet may be bolted together to make up portion 24. Long bolts may be used to push the plates 30 together. Shorter bolts and notches may then be used to attach plates together. The shape of plates 30 can be optimised to fit manufacturing process. Steel slabs 31 (which together make up the portions 26) may be bolted to plates 30 and adjacent steel slabs 31. It is also possible to use inter-connecting notches on all plates and slabs to aid torque transfer for turning the rotatable piece 12.

Referring back to the rotatable capacity of the rotatable pieces 12 between several positions. For example, in one position of the rotatable pieces 12, the magnitude of the vertical magnetic field is maximum in the particle acceleration chamber. In FIGS. 1 and 4, the rotatable pieces 12 are in said position. The North and South poles of the rotatable pieces 12 are oriented vertically, so that the magnetic field is maximised in the particle acceleration chamber 14 (ON position of the pieces 12). In another position of the rotatable pieces 12, the magnitude of the vertical magnetic field is minimized in the particle acceleration chamber (OFF position of the pieces 12). In FIG. 5 (which also applies to the embodiment of FIG. 1), the rotatable pieces 12 are in said another position. The North and South poles of the rotatable pieces 12 are oriented horizontally. The magnitude of the vertical magnetic field is minimized in the particle acceleration chamber. In this position, the cyclotron can be opened, the force to open the cyclotron being minimized.

The rotatable pieces 12 can be rotatable between discrete positions. Alternatively, the rotatable piece 12 can be continuously rotatable. These make it possible to fine tune the position of the rotatable pieces to adjust the magnetic field to the desired magnitude. According to the figures, the rotatable pieces 12 are accessible from the outside (or from the periphery) of the cyclotron to rotate them towards the desired position. The position of the rotatable pieces 12 can be adjusted manually or can be motorized. In order to adjust the angular position of the rotatable pieces 12, holes 32 are provided in the rotatable pieces 12. The holes 32 are provided throughout the plates 30. Holes 32 extend in parallel to axis 18. Rotation of the rotatable pieces 12 is done via a tool inserted into the holes 32. The rotatable pieces may be rotated independently of each other. This makes it possible to also fine tune the position of each rotatable piece 12 to adjust the (vertical) magnetic field to the desired magnitude in the chamber 14 (and to reach the ON and OFF positions).

FIG. 8 illustrates a further embodiment that can be combined to the preceding figures. The cyclotron 10 may further comprise one or more electrically powered coils 34. The electrically powered coil(s) 34 are configured to apply a magnetic field in the chamber 14 by powering the coil(s). The coil(s) 34 can be used to adjust the magnetic field generated in the particle acceleration chamber 14. The coil(s) 34 can be used to generate an additional magnetic field or a magnetic field opposing that generated by the rotating pieces 12. The magnetic coil(s) make it possible to reduce the size and cost of the rotatable pieces 12, and thus, of the cyclotron 10. The combination of rotatable pieces 12 and coil(s) 34 both generating a magnetic field lowers the running cost of a cyclotron only equipped with coils. With such a combination, the cyclotron is designed as an hybrid cyclotron 10. The power supply is also smaller and cheaper in the frame of the disclosure. The coil(s) 34 can be small and can fit into smaller spaces, to not increase the overall size of the cyclotron 10. This offers more space for other equipment. The coil(s) 34 may be positioned in a groove within the upper and/or lower parts 101 and 102. The coil(s) 34 may be positioned between the extremity 121 of the rotatable pieces 12 and the poles 22. The coil(s) 34 may be centered on the central axis 11. The coil(s) 34 may surround the central region, and more specifically the chamber 14. In addition, the use of coil(s) make it possible to provide rotatable pieces 12 with smaller size, which lowers the permanent magnet rotational torques. It is thus easier to engineer rotation mechanics. Coil(s) 34 help rotatable pieces 12 stay magnetized.

The disclosure also relates to a method for operating the cyclotron 10. The method comprises the regulation of the magnetic field. To this end, the method comprises steps of rotating at least some of the rotatable pieces towards respective positions, wherein, in one position of the rotatable pieces, the magnitude of the vertical magnetic field is maximized in the particle acceleration chamber and in another position of the rotatable pieces, the magnitude of the vertical magnetic field is minimized in the particle acceleration chamber. All of the rotatable pieces 12 may be rotated and adjusted in the desired position. Other positions are possible, in order to adjust the magnitude of the vertical magnetic field. Also, if coil(s) 34 are implemented, the position of the rotatable pieces 12 are adjusted in consequence. The method offers flexibility in the operation of cyclotron 10.

Also, the method may comprise a step of opening the cyclotron 10. To this end, in the position of the rotatable pieces 12 where the magnitude of the vertical magnetic field is minimized in the particle acceleration chamber 14, the method comprises a step of opening the cyclotron by separating the upper part 101 and the lower part 102 from one another. This allows maintenance operations to be carried out in the cyclotron by the operators in a safe way.

The magnetic field in the central region may reach up to 2 Tesla. When the magnetic field is on, the flux is forced through central region and poles 22. When the magnetic field is off, the flux travels between adjacent rotatable pieces 12. Fringe field when on can be reduced by better matching rotatable pieces 12 edges to yoke.

The proposed solution of a cyclotron with two rows of cone shaped pieces with permanent magnets in the return yoke allows the magnetic field to be varied and/or turned off for tuning and/or interventions. These permanent magnets are incorporated into cone shapes, which can be rotated. This can also be supplemented with a lower-current coil, to keep power consumption low. With a variable magnetic field generated in the cyclotron 10, the cyclotron has the ability to turn field off and to be opened. The cyclotron 10 is a compact cyclotron that is optimized to provide high magnetic field and that offers flexibility to facilitate cyclotron maintenance. The magnetic field of the cyclotron 10 can be adjusted to keep isochronicity as permanent magnet demagnetizes (notably with a magnetic field measurement device). When turned on, the field can be returned to the same value (under 2 Gauss difference) after the field has been turned off. The cyclotron 10 is radiation hard.

It is noted that some of the pieces 12 may be rotatable and others pieces 12 not. For example half of the pieces 12 are rotatable and half of the pieces 12 are not rotatable. The rotatable pieces and non-rotatable pieces may have an identical design (the non-rotatable and rotatable pieces canceling when in the OFF position, in which the rotating are 180-degrees from ON position).

The present disclosure has been described in relation to specific embodiments, which are purely illustrative and are not to be regarded as limiting. Generally speaking, it will be apparent to a person skilled in the art that the present disclosure is not limited to the examples illustrated and/or described above.

What is claimed is:

1. A cyclotron, comprising:
a particle acceleration chamber;
an upper part above the particle acceleration chamber and a lower part below the particle acceleration chamber, the upper part and the lower part being separable from one another; and
a plurality of rotatable pieces for generating a magnetic field in the particle acceleration chamber, wherein:
at least one of the rotatable pieces is at least partly made of a permanent magnet material;
the at least one of the rotatable pieces extends along a respective axis, the respective axis being oriented toward the particle acceleration chamber, the at least one of the rotatable pieces comprising a first extremity and a second extremity, the first extremity being closer to a central axis of the cyclotron than the second extremity;
the at least one of the rotatable pieces is rotatable about the respective axis between a plurality of angular positions, the magnetic field generated by the plurality of rotatable pieces in the particle acceleration chamber being based on at least one of the angular positions; and
the at least one of the rotatable pieces has a plurality of cross sections, a first of the cross sections closer to the central axis of the cyclotron being smaller than a second of the cross sections farther from the central axis of the cyclotron, the cross sections of the at least one of the rotatable pieces being transverse to the respective axis.

2. The cyclotron according to claim 1, wherein areas of the cross sections decrease along the respective axis towards the first extremity.

3. The cyclotron according to claim 1, wherein:
the at least one of the rotatable pieces has a truncated cone shape, and
areas of the cross sections of the at least one of the rotatable pieces in the truncated cone shape decrease towards the first extremity.

4. The cyclotron according to claim 1, further comprising:
a return yoke surrounding the particle acceleration chamber, the plurality of rotatable pieces being arranged in the return yoke.

5. The cyclotron according to claim 1, wherein the respective axis of the at least one of the rotatable pieces obliquely points towards a median plane within the particle acceleration chamber, or is parallel to the median plane.

6. The cyclotron according to claim 1, wherein the respective axis of the at least one of the rotatable pieces points towards the central axis of the cyclotron.

7. The cyclotron according to claim 1, wherein:
the at least one of the rotatable pieces comprises a stack of permanent magnet plates fixed to one another,
a first of the permanent magnet plates is closer to the central axis of the cyclotron than a second of the permanent magnet plates, and
the first of the permanent magnet plates has a surface with an area smaller than an area of a surface of the second of the permanent magnet plates.

8. The cyclotron according to claim 1, wherein the at least one of the rotatable pieces comprises:
a first portion at least partly surrounding the respective axis, the first portion being located between two planes within the at least one of the rotatable pieces, the two planes being parallel to the respective axis and on two sides of the respective axis, and the first portion being of a permanent magnet material; and
two second portions assembled with the first portion on the two planes and on the two sides of the respective axis, the two second portions being of material of magnetic relative permeability greater than 1.

9. The cyclotron according to claim 1, wherein the plurality of rotatable pieces are configured to generate the magnetic field with
a maximum magnitude in a vertical direction in the particle acceleration chamber when the at least one of the rotatable pieces is rotated to a first of the angular positions, and
a minimum magnitude in the vertical direction in the particle acceleration chamber when the at least one of the rotatable pieces is rotated to a second of the angular positions.

10. The cyclotron according to claim 1, wherein the plurality of rotatable pieces are continuously rotatable.

11. The cyclotron according to claim 1, wherein the plurality of rotatable pieces are configured for external access to be rotated towards one or more of the angular positions.

12. The cyclotron according to claim 1, wherein the plurality of rotatable pieces are rotatable independently of each other.

13. The cyclotron according to claim 1, wherein the magnetic field is a first magnetic field, the cyclotron further comprising:
one or more coils configured to be electrically powered to form a second magnetic field in the particle acceleration chamber.

14. The cyclotron according to claim 1, wherein the plurality of rotatable pieces include two groups of rotatable pieces arranged symmetrically to a median plane within the particle acceleration chamber and between the upper part and the lower part.

15. A method for operating a cyclotron, the method comprising:
rotating a plurality of rotatable pieces of the cyclotron towards a plurality of angular positions, wherein the plurality of rotatable pieces are configured to form a magnetic field with
a maximum magnitude in a vertical direction in a particle acceleration chamber of the cyclotron when the plurality of rotatable pieces are rotated to a first of the angular positions, or
a minimum magnitude of the magnetic field in the vertical direction in the particle acceleration chamber when the plurality of rotatable pieces are rotated to a second of the angular positions; and
opening the cyclotron by separating an upper part and a lower part of the cyclotron when the magnetic field has the minimum magnitude in the vertical direction in the particle acceleration chamber.

16. The method according to claim 15, wherein the magnetic field is a first magnetic field, the method comprising:
forming a second magnetic field in the particle acceleration chamber by one or more electrically powered coils.

17. A cyclotron, comprising:
a particle acceleration chamber; and
a plurality of rotatable magnetic pieces configured to generate a magnetic field in the particle acceleration chamber,
wherein:
the plurality of the rotatable magnetic pieces are respectively configured to rotate about a respective axis between a plurality of angular positions, and
the respective axis obliquely points towards a median plane within the particle acceleration chamber, or is parallel to the median plane.

18. The cyclotron according to claim 17, wherein the plurality of rotatable magnetic pieces respectively comprise:
a first portion of a permanent magnet material; and
two second portions of material of magnetic relative permeability greater than 1,
wherein the second portions are assembled on two sides of the first portion.

19. The cyclotron according to claim 17, further comprising:
an upper part above the particle acceleration chamber;
a lower part below the particle acceleration chamber, wherein the upper part is separable from the lower part; and
a return yoke surrounding the particle acceleration chamber, wherein the plurality of rotatable magnetic pieces are arranged in the return yoke.

20. The cyclotron according to claim 19, wherein the magnetic field is a first magnetic field, the cyclotron further comprising:
one or more coils configured to form a second magnetic field in the particle acceleration chamber.
